(19) United States
(12) Patent Application Publication
(10) Pub. No.: US 2008/0134131 A1
(43) Pub. Date: Jun. 5, 2008

(54) Simulation model making method

(76) Inventors: Masafumi Asano, Yokohama-shi (JP); Masaki Satake, Yokohama-shi (JP); Satoshi Tanaka, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/976,025

(22) Filed: Oct. 19, 2007

(30) Foreign Application Priority Data
Oct. 20, 2006 (JP) 2006-286914
Sep. 21, 2007 (JP) 2007-245064

(51) Int. Cl. G06F 17/50

(52) U.S. Cl. 716/21

(57) ABSTRACT

A method of making a simulation model, includes specifying a feature factor which characterizes a pattern layout of a mask pattern, specifying a control factor which affects a dimension of a resist pattern to be formed on a substrate by means of a lithography process using the mask pattern, determining a predicted dimension of the resist pattern to be formed on the substrate by means of the lithography process using the mask pattern through the use of a model based on the feature and control factors, obtaining an actual dimension of the resist pattern actually formed on the substrate by means of the lithography process using the mask pattern, and setting the feature and control factors and the predicted dimension as input layers and setting the actual dimension as an output layer to construct a neural network.

### CROSS-REFERENCE TO RELATED APPLICATIONS

This application is based upon and claims the benefit of priority from prior Japanese Patent Applications No. 2006-286914, filed Oct. 20, 2006; and No. 2007-245064, filed Sep. 21, 2007, the entire contents of both of which are incorporated herein by reference.

### BACKGROUND OF THE INVENTION

1. Field of the Invention

The present invention relates to a method of making a simulation model.

2. Description of the Related Art

As circuit density increases in semiconductor devices, the problem of optical proximity effect (OPE) has become increasingly severe. In order to compensate for variations in pattern dimensions due to the OPE, it is required to make optical proximity correction (OPC) on the mask pattern.

To make OPC, it is important to predict the effects of OPE in advance. Usually, lithography simulation is used for this prediction. The lithography simulation involves aerial image calculations based on diffraction theory and process simulation to predict the process effects of a photoresist or the like.

It is possible to apply a highly precise physical model to the aerial image calculations; however, it is difficult to precisely make a physical model that reflects the process effects of a photoresist or the like. Up to now, therefore, it has been difficult to make a highly precise simulation model.

A simulation model using a neural network has been proposed in an article entitled “Neural Network based approach to resist modeling and OPC” by Franz Zach, Proc. of SPIE vol. 5377, pp. 670-679, 2004. However, merely making a simulation model using a neural network is not enough to perform precise simulation.

### BRIEF SUMMARY OF THE INVENTION

A first aspect of the present invention, there is provided a method of making a simulation model, comprising: specifying a feature factor which characterizes a pattern layout of a mask pattern; specifying a control factor which affects a dimension of a resist pattern to be formed on a substrate by means of a lithography process using the mask pattern; determining a predicted dimension of the resist pattern to be formed on the substrate by means of the lithography process using the mask pattern through the use of a model based on the feature and control factors; obtaining an actual dimension of the resist pattern actually formed on the substrate by means of the lithography process using the mask pattern; and setting the feature and control factors and the predicted dimension as input layers and setting the actual dimension as an output layer to construct a neural network.

A second aspect of the present invention, there is provided a method of making a simulation model, comprising: specifying a feature factor which characterizes a pattern layout of a mask pattern; specifying a control factor which affects a dimension of a pattern to be formed on a substrate by means of an etching process using a resist pattern based on the mask pattern as a mask; obtaining an actual dimension of a pattern actually formed on the substrate by means of the etching process using the resist pattern based on the mask pattern as a mask; and setting the feature and control factors and a dimension of the resist pattern as input layers and setting the actual dimension or a difference between the actual dimension and the dimension of the resist pattern as an output layer to construct a neural network.

A third aspect of the present invention, there is provided a method of making a simulation model, comprising: obtaining an actual dimension of a resist pattern actually formed on a substrate by means of a lithography process using a mask pattern; determining a first intensity distribution based on an optical image of the mask pattern through the use of a first lithography simulation model using a physical parameter; determining a second intensity distribution by applying a second lithography simulation model using an experimental parameter to the first intensity distribution; determining a predicted dimension of the resist pattern to be formed on the substrate by means of the lithography process using the mask pattern on the basis of the second intensity distribution; determining a feature quantity of the second intensity distribution; and setting the feature quantity as an input layer and setting a difference between the actual and predicted dimensions as an output layer to construct a neural network.

### BRIEF DESCRIPTION OF THE SEVERAL VIEWS OF THE DRAWING

FIG. 1 is a flowchart which schematically illustrates a method of making a simulation model according to a first embodiment of the present invention;

FIG. 2 schematically illustrates the concept of a neural network according to first, second and third embodiments of the present invention;

FIG. 3 shows advantages of the first embodiment;

FIG. 4 is a flowchart which schematically illustrates a method of making a simulation model according to a second embodiment of the present invention;

FIG. 5 is a flowchart which schematically illustrates a method of making a simulation model according to a third embodiment of the present invention;

FIG. 6 is a diagram for use in explanation of the third embodiment; and

FIG. 7 is a flowchart which schematically illustrates a method of manufacturing a semiconductor device in accordance with the first, second and third embodiments of the present invention.

### DETAILED DESCRIPTION OF THE INVENTION

Embodiments of the present invention will be described hereinafter with reference to the accompanying drawings.

### Embodiment 1

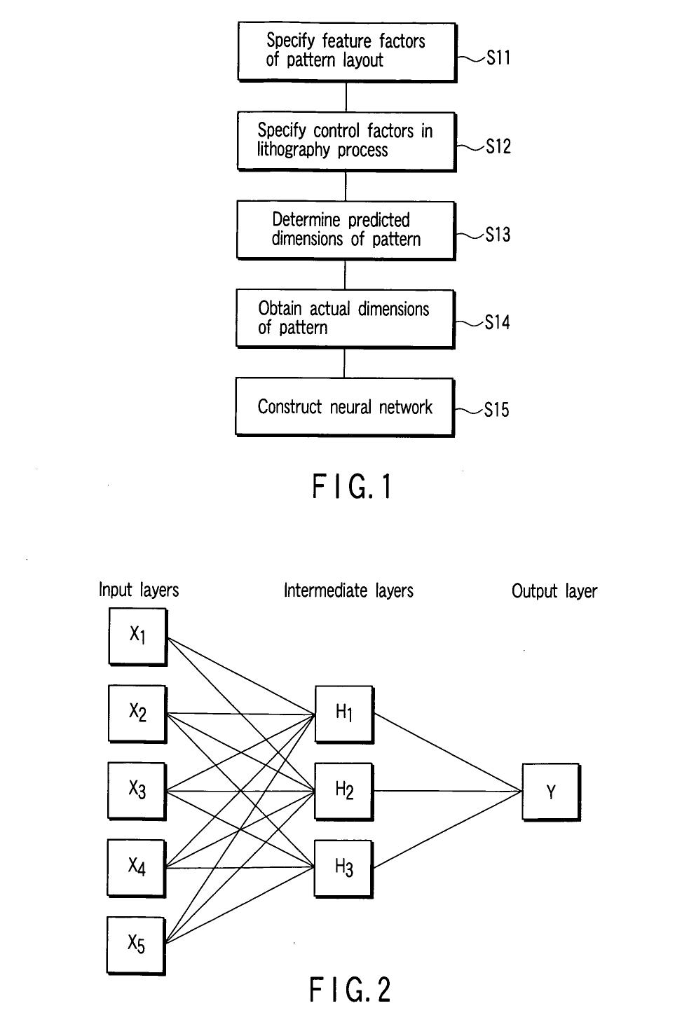

FIG. 1 is a flowchart which schematically illustrates a method of making a simulation model according to a first embodiment.

In step S11, feature factors are specified which characterize the pattern layout of a mask pattern. That is to say, feature factors based on pattern layout information are set in a system (a computer or the like) for making a simulation model. The feature factors include target dimensions (pattern widths, space widths, etc.) of the pattern, pattern pitches, the rate of area taken up by the pattern (pattern area rate) within a given region, and the number of patterns within a given region.

In step S12, control factors are specified which affect the dimensions of the pattern to be formed on a substrate by means of a lithography process. That is, control factors that control the dimensions of the pattern to be formed on a substrate by means of a lithography process are set in the simulation model making system (computer or the like). The control factors include the exposure amount in the photolithographic process, the focusing and illumination conditions, the numerical aperture (NA) of the optical system of an exposure apparatus, the aberration of the lens of the exposure apparatus, the type of photoresist, the mask dimensions, and the mask bias. In general, variations in the values of the control factors result in variations in the dimensions of the pattern formed on the substrate.

In step S13, predicted dimensions of the pattern to be formed on the substrate are determined by using a physical model specified by the feature and control factors. The physical model includes a physical model that represents diffraction at the mask pattern. Specifically, aerial image calculations based on diffraction theory are performed using the feature and control factors and the predicted dimensions of the pattern to be formed on the substrate are determined by simulation. More specifically, simulation is performed under a plurality of conditions in which the control factors are different in value for each of a plurality of test patterns having different feature factor values to determine the predicted dimensions of each of the patterns. The aerial image corresponds to an optical image of exposure light that passes through the photomask and falls on the photoresist.

In step S14, the actual dimensions of the pattern actually formed on the substrate by means of the photolithographic process are obtained. Specifically, for each of the plurality of test patterns having different feature factor values, a photolithographic process is actually performed under a plurality of conditions in which the control factors differ in value to actually form patterns on the substrate. The dimensions of each of the patterns thus actually formed are measured. The measured dimensions are then entered into the simulation model making system (computer or the like) and are obtained by the system.

In step S15, the feature factors, the control factors and the predicted dimensions are set as input layers and the actual dimensions are set as an output layer to construct (build) a neural network. As can be seen from the description in steps S13 and S14, variations in the feature and control factors result in variations in the predicted and actual dimensions. Therefore, when setting the feature and control factors and the predicted dimensions as input layers and the actual dimensions as output layer, a neural network is constructed so that the input layers (the feature and control factors and the predicted dimensions) are connected with the output layer (the actual dimensions) in an appropriate relationship to exactly reflect the measurements (experimental results).

FIG. 2 schematically illustrates the concept of the aforementioned neural network. In the input layers, for example, X1 and X2 correspond to the feature factors, X3 and X4 correspond to the control factors, and X5 corresponds to the predicted dimensions. In the output layer, Y corresponds to the actual dimensions. H1, H2 and H3 of intermediate layers are set so as to connect the input layers with the output layer properly.

Next, a specific example of this embodiment will be described.

First, in order to obtain the actual dimensions of a pattern actually formed on a substrate by means of a photolithographic process, the following processing was performed. First, an anti-reflection coating and a photoresist layer were formed in sequence on a substrate containing a semiconductor wafer. Subsequently, a test pattern formed on a photomask was transferred to the photoresist layer by an ArF exposure apparatus. The test pattern includes a plurality of types of line and space (L/S) patterns. The line and space pattern target values have been set for each type. After the photoresist layer was developed to form a resist pattern, the dimensions of the resist pattern were measured by a scanning electron microscope (SEM).

A predictive model (simulation model) of this embodiment and a predictive model (simulation model) of a comparative example were made on the basis of the experimental results (measurements) and then the predictive results of the two models were compared.

A combination of an aerial image model and a resist model was used as the simulation model of the comparative example and the parameters of the simulation model were determined so as to exactly reflect the aforementioned experimental results (measurements). In the simulation, first, aerial image calculations were performed on the basis of the dimensions of the pattern formed on the photomask and exposure conditions to determine the intensity distribution in the optical image on the wafer surface. Then, the intensity distribution and a Gaussian function were convoluted to modulate the intensity distribution. That is, the Gaussian function is used to approximate the resist model. The intensity distribution thus obtained was sliced at a given intensity level to obtain the predicted dimensions.

The simulation of this embodiment will be described next. First, as feature factors that characterize the pattern layout, a line target value (LT) and a space target value (ST) were determined for each pattern. Subsequently, as a control factor that affects the pattern dimensions, the actual dimensions (M) of the pattern formed on the photomask were determined. Furthermore, the predicted dimensions (IW) of the pattern to be formed on the substrate were calculated through aerial image calculations. Then, a relationship between the actual pattern dimensions w and the variables (LT, ST, M and IW) was determined so that the above experimental results (measurements) were reflected accurately. The relationship is represented by

w=f(LT, ST, M, IW)

The above function f can be defined by constructing a neural network. That is, the function can be defined by such a neural network as has input, intermediate and output layers as shown in FIG. 2. The relationship between the input and intermediate layers and the relationship between the intermediate and output layers can be determined by learning experimental data (measured data). A concrete form of the function is represented by

$$w = \{ d + {\sum }_{j = 1}^{{N}_{H}} [ {b}_{j} {S}_{H} ( {c}_{j} + {\sum }_{i = 1}^{{N}_{x}} ( {a}_{ij} {x}_{i} ) ) ] \} * {σ}_{w} + {w}_{m}$$

Here, σ_{w} and wₘ are the standard deviation and the average value, respectively, of the dimension measured values in the experimental data. xi represent feature factors and variation factors (control factors, predicted dimensions). aᵢⱼ, bⱼ, cⱼ and d indicate coefficients determined by learning using experimental data. S_{H} stands for a Logistic function. Nₓ represents the number of the feature and control factors (here the factors are LT, ST, M and IW and totals four). N_{H} stands for the number of the intermediate layers.

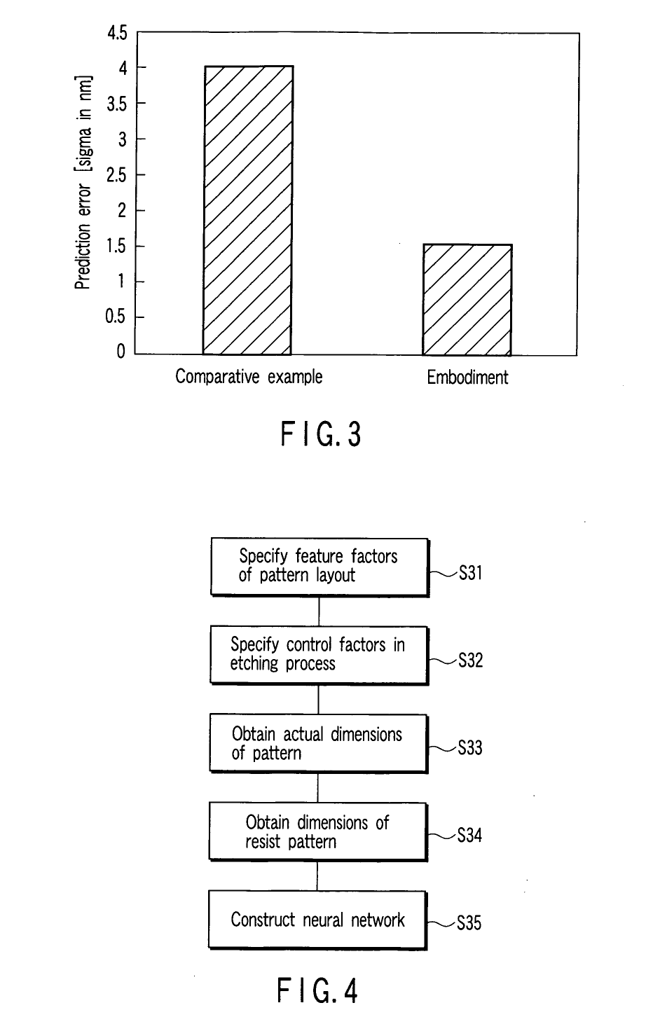

FIG. 3 shows the advantages of the embodiment relative to the comparative example. Specifically, FIG. 3 shows the standard deviation (corresponding to predicted errors) of the differences between actual dimensions and predicted dimensions of the pattern. As can be seen from FIG. 3, the use of the method of this embodiment allows the prediction errors to be reduced greatly.

As described above, the embodiment is configured to construct a neural network which is a nonlinear regression model with the feature factors, control factors, and predicted dimensions as the input layers and the actual dimensions as the output layer. Thereby, a precise lithography simulation model can be made, allowing precise simulation to be carried out. In particular, prediction accuracy (simulation accuracy) can be increased drastically by including the predicted dimensions determined using a physical model defined by the feature and control factors among the input layers, thus allowing precise simulation to be carried out.

### Embodiment 2

FIG. 4 is a flowchart which schematically illustrates a method of making a simulation model according to a second embodiment.

In step S31, feature factors are specified which characterize the pattern layout of a mask pattern. That is to say, feature factors based on pattern layout information are set in a system (a computer or the like) for making a simulation model. The feature factors include target dimensions (pattern widths, space widths, etc.) of the pattern, pattern pitches, the rate of area taken up by the pattern (pattern area rate) within a given region, and the number of patterns within a given region.

In step S32, control factors are specified which affect the dimensions of the pattern to be formed on a substrate by means of an etching process. That is, control factors that control the dimensions of the pattern to be formed on a substrate by means of an etching process are set in the simulation model making system (computer or the like). Here, the etching process refers to a process of carrying out etching using a resist pattern obtained by a photolithographic process as a mask. The above control factors include the etching time, the etching temperature, the pressure of an etching atmosphere, and the flow rate of an etching gas. In general, variations in the values of the control factors result in variations in the dimensions of the pattern formed on the substrate.

In step S33, the actual dimensions of the pattern actually formed on the substrate by means of the etching process using a resist pattern as a mask are obtained. Specifically, for each of a plurality of test patterns having different feature factor values, an etching process is actually performed to form patterns on a substrate under a plurality of conditions in which the control factors differ in value. The dimensions of each of the patterns thus actually formed are measured. The measured dimensions are then entered into the simulation model making system (computer or the like) and are obtained by the system.

In step S34, the dimensions of the resist pattern are obtained. Specifically, for each of the test patterns having different feature factor values, the dimensions of each resist pattern is obtained under the conditions in which the control factor values differ. The photoresist pattern may be assumed to be an actually formed one or a simulation-predicted one.

In step S35, a neural network is constructed with the feature factors, the control factors and the dimensions of the resist patterns set as input layers and the actual dimensions obtained in step S33 set as an output layer. In place of the actual dimensions obtained by the etching process, the difference between the actual dimensions obtained by the etching process and the dimensions of the resist pattern may be used as the output layer. As can be seen from the description in steps S33 and S34, variations in the feature and control factors result in variations in the actual dimensions of a pattern after etching and the dimensions of the resist pattern. Therefore, when setting the feature and control factors and the resist pattern dimensions as the input layers and the actual dimensions as the output layer, a neural network is constructed so that the input layers (the feature and control factors and the resist pattern dimensions) are connected with the output layer (the actual dimensions) in an appropriate relationship to exactly reflect the measurements (experimental results).

FIG. 2 schematically illustrates the concept of the aforementioned neural network. In the input layers, for example, X₁ and X₂ correspond to the feature factors, X₃ and X₄ correspond to the control factors, and X₅ corresponds to the resist pattern dimensions. Y in the output layer corresponds to the actual dimensions (or the difference between the actual dimensions and the resist pattern dimensions). H₁, H₂ and H₃ of intermediate layers are set so as to connect the input layers with the output layer properly.

As described above, the second embodiment is configured to construct a neural network which is a nonlinear regression model with the feature factors, control factors, and resist pattern dimensions as the input layers and the actual dimensions (or the difference between the actual dimensions and the resist pattern dimensions) as the output layer. Thereby, a precise etching simulation model can be made, allowing precise simulation to be carried out. In particular, prediction accuracy (simulation accuracy) can be increased drastically by including the resist pattern dimensions among the input layers, thus allowing precise simulation to be carried out.

In the etching process, dimension differences dependent upon the pattern area rate (resist pattern coverage rate) tend to occur due to the micro loading effect. With a conventional simulation model, it is difficult to incorporate the micro loading effect into a physical model and therefore difficulties are involved in achieving precise simulation. In this embodiment, the micro loading effect can be incorporated into the physical model by including the pattern area rate within a given region (for example, 10 μm square region) (or the number of patterns within a given region) among the feature factors, allowing precise simulation to be carried out.

In the second embodiment, as in the first embodiment, a relationship between the input and output layers is determined by learning experimental data (measured data) to construct a neural network. As a result, the use of the method of the second embodiment confirmed that the prediction accuracy (simulation accuracy) could be increased drastically.

### Embodiment 3

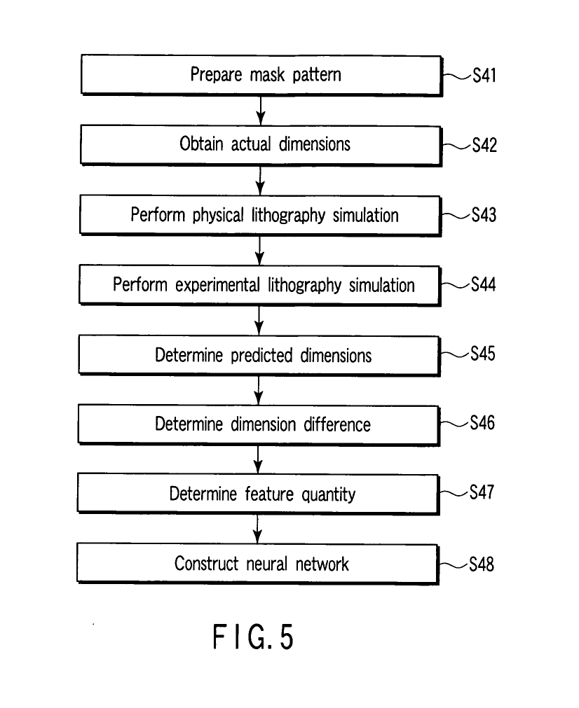

FIG. 5 is a flowchart which schematically illustrates a method of making a simulation model according to a third embodiment.

In step S41, a plurality of types of mask patterns is prepared as test patterns used in lithography simulation. Specifically, the mask patterns include line and space patterns, isolated patterns, and island patterns.

In step S42, the actual dimensions of a resist pattern are obtained which is actually formed on a substrate through a lithography process using a mask pattern. Specifically, the mask pattern is transferred to a photoresist on a semiconductor substrate by means of an exposure apparatus and a development process is then carried out to form the resist pattern. The dimensions of the resist pattern thus actually formed are measured with a scanning electron microscope (SEM). The measured dimensions are entered into a system (a computer or the like) for making a simulation model, and are obtained by the system.

In step S43, physical lithography simulation is performed. That is, the intensity distribution of an optical image (a first intensity distribution) is determined for each of the mask patterns through the use of a physical lithography simulation model which uses physical parameters. The physical lithography simulation model includes a diffraction and imaging model, as a physical model, which represents a phenomenon in which exposure light from a light source is diffracted by the mask pattern and is imaged by the lens. As the diffraction model use may be made of a vector model. The physical parameters include the numeral aperture (NA) of the optical system, the illumination distribution, and the refractive index and damping coefficient of a photoresist. These physical parameters are equal in value to those used in the lithography process in step S42.

In step S44, experimental lithography simulation is carried out. That is, an experimental lithography simulation model using the experimental parameters is applied to the first intensity distribution to determine a second intensity distribution. The experimental lithography simulation model is one that equivalently represents physical phenomena using experimental parameters which are different from physical ones when mere physical parameters are not enough to predict the results with high accuracy. The experimental parameters in the experimental lithography simulation model are determined on the basis of experimental values (actual values) and normally optimized so that the difference between experimental and simulation values is minimized.

In this embodiment, as the experimental lithography simulation model a diffusion model is used which represents the diffusion of an acid in the photoresist after exposure. The diffusion model is represented by

P(x,y)=w1×G(x,y, ΔL1)*S(x,y)+W2×G(x,y, ΔL2)*S(x,y)

where S(x, y) is the intensity distribution of the optical image determined by the physical lithography simulation in step S42, G(x, y, ΔL) is a Gaussian function having a standard deviation of ΔL, P(x, y) is the intensity distribution in the photoresist determined by the experimental lithography simulation in step S43, w1, w2, AL1 and AL2 are the experimental parameters, and “*” stands for convolution. That is, in this embodiment, the diffusion model of the photoresist is approximated by the Gaussian function.

In step S45, the predicted dimensions of the resist pattern to be formed on the substrate by means of the lithography process are determined on the basis of the second intensity distribution obtained by the experimental lithography simulation. Specifically, the predicted dimensions of the resist pattern can be obtained by slicing the intensity distribution P(x, y) obtained in the above manner at a given intensity level. The values of the experimental parameters (w1, w2, AL1 and AL2) are optimized so that the difference between the predicted dimensions and the actual dimensions (experimental results obtained in step S42) of the resist pattern is minimized. As an optimizing algorithm, use may be made of a simplex method by way of example.

In step S46, the difference between the actual dimensions of the resist pattern obtained in step S42 and the predicted dimensions of the resist pattern finally determined in step S45 is calculated.

In step S47, the feature quantity of the second intensity distribution obtained by the experimental lithography simulation is determined. The feature quantity is obtained by causing a given function or filter to act on the second intensity distribution.

In this embodiment, the feature quantity of the intensity distribution is determined using disk functions. Specifically, the feature quantity is represented by

Circ(r1,r2)=I(x,y)*Disk(r1)−I(x,y)*Disk(r2)

where I(x, y) is the second intensity distribution, Disk(r1) and Disk(r2) are disk functions, and * stands for convolution.

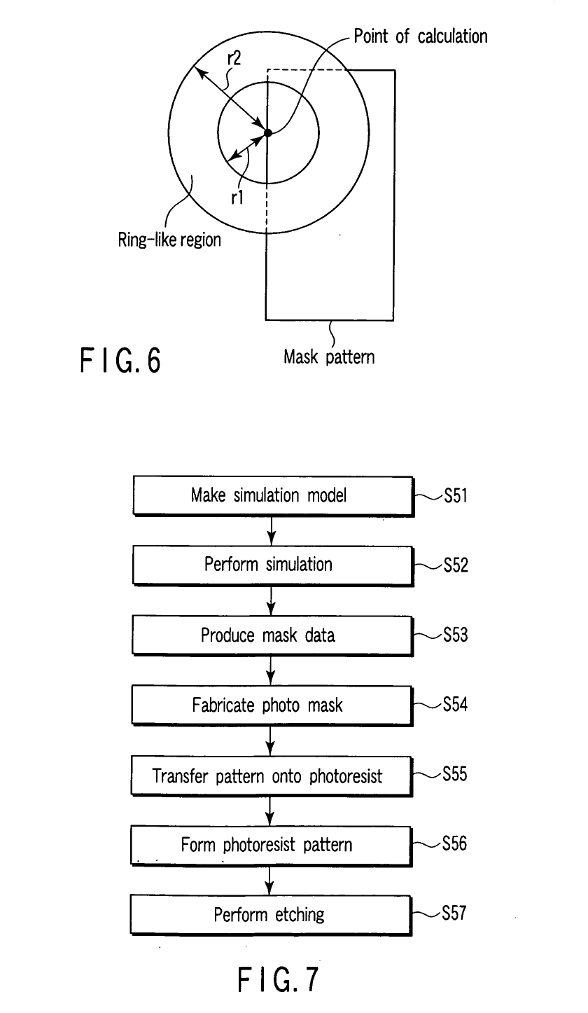

Disk(r1) is a function which is 1 if r<r1 and 0 if r≧r1. Disk(r2) is a function which is 1 if r<r2 and 0 if r≧r2. Thus, Circ(r1, r2) is represented by convolution of the second intensity distribution and a ring-like region (region defined by r1<r<r2). FIG. 6 is a schematic representation of such a ring-like region. In this embodiment, ten ring-like regions having different radii are closely arranged and convolution is performed for each of the regions to calculate the feature quantity.

In this embodiment, the feature quantity of the second intensity distribution is determined by convolution of the second intensity distribution and disk functions. However, this is not restrictive. The feature quantity may be determined by convolution of the second intensity distribution and a Gaussian function or convolution of the second intensity distribution and an Fourier-Bessel function. Furthermore, the feature quantity may be determined by causing an IIR or FIR filter to act on the second intensity distribution.

In step S48, the feature quantity obtained in step S47 is set in the input layers and the dimension difference (difference between actual and predicted dimensions of the resist pattern) obtained in step S46 is set in the output layer to construct a neural network. That is, when setting the feature quantity as the input layer and the dimension difference as the output layer, a neural network is constructed so that the input layer (the feature quantity) is connected with the output layer (the dimension difference) in an appropriate relationship to accurately reflect the measurements (experimental results).

FIG. 2 schematically illustrates the concept of the aforementioned neural network. In the input layers, for example, X₁ to X₅ correspond to the predicted dimensions. Y in the output layer corresponds to the dimension difference. H₁, H₂ and H₃ of intermediate layers are set so as to connect the input layers to the output layer properly.

As described above, the third embodiment is configured to construct a neural network which is a nonlinear regression model with the feature quantity of the second intensity distribution as an input layer and the difference between the actual and predicted dimensions of the resist pattern as an output layer. Thereby, a precise lithography simulation model can be made, allowing precise simulation to be carried out.

That is, in the third embodiment, a first intensity distribution is first determined through the use of a physical lithography simulation model using physical parameters and then a second intensity distribution is determined through the use of an experimental lithography simulation model using experimental parameters for physical phenomena which involve difficulties in measuring physical parameters. In order to further reduce the difference between resist pattern predicted dimensions obtained from the second intensity distribution and resist pattern actual dimensions, a neural network is then constructed with the feature quantity of the second intensity distribution as the input layer and the dimension difference as the output layer. Thereby, a lithography simulation model can be made which is excellent in both the fitting accuracy and the prediction accuracy.

The results of evaluation of this embodiment will be described hereinafter.

For each of the simulation model of this embodiment and the simulation model of a first comparative example, the root mean square (RMS) of the difference between the simulation and actual dimensions of a resist pattern was calculated. In the comparative example, a simulation model is used which is merely a combination of a physical lithography simulation model and an experimental lithography simulation model. In the comparative example, the RMS of the dimension difference was 20.5 nm. In contrast, in this embodiment, the RMS was 2.5 nm. Therefore, it can be seen that this embodiment can provide a simulation model which is excellent in fitting accuracy.

Additionally, for a simulation model of a second comparative example the root mean square (RMS) of the difference between the simulation and actual dimensions of a resist pattern was calculated. In the comparative example, the feature quantity was determined by causing a ring-like function to directly act on a mask pattern. That is, the feature quantity was determined by convolution of the mask pattern and the ring-like function and then a neural network was constructed. As a result, the RMS of the dimension difference was 3.1 nm. However, for a pattern other than a mask pattern used for constructing (learning) a neural network, the RMS of the dimension difference was calculated to be 2.9 nm in the case of this embodiment and be 25 nm in the case of the comparative example. That is, in the case of this embodiment, the results of simulation are also obtained with high accuracy for a pattern other than a mask pattern used for constructing (learning) a neural network. Therefore, it can be seen that this embodiment can provide a simulation model which is excellent in prediction accuracy.

From the foregoing, it can be seen that this embodiment can provide a simulation model which is excellent in both the fitting accuracy and the prediction accuracy.

In the first, second and third embodiments described above, a mono-layer perceptron, a multi-layer perceptron or a support vector machine can be used for the neural network.

Furthermore, the simulation model making methods described in the first, second and third embodiments can be applied to the manufacture of semiconductor devices. FIG. 7 is a flowchart which schematically illustrates a method of manufacturing a semiconductor device.

First, a simulation model is made in accordance with the aforementioned methods (step S51). Then, simulation is carried out using the simulation model to predict a pattern to be formed on a semiconductor wafer (step S52). Next, OPC (Optical Proximity Correction) is made on design data on the basis of the simulation results to produce mask data (step S53). Furthermore, a photomask is fabricated on the basis of the mask data thus produced (step S54). The pattern formed on the photomask thus produced is transferred to a photoresist on the semiconductor wafer (step S55). Then, the photoresist is developed to form a photoresist pattern (step S56). Next, using the photoresist pattern as a mask, etching is performed to form a pattern on the semiconductor substrate (step S57).

The use of the simulation models made in accordance with the first, second and third embodiments can provide precise simulation, allowing a proper photomask to be fabricated. Therefore, such a proper photomask allows a precise pattern to be formed on a semiconductor wafer.

The method described in each of the first, second and third embodiments can be implemented on a computer the operation of which is controlled by a program in which the procedure of that method has been described. The program is available through a recording medium, such as a magnetic disk, or a wire or wireless communication line, such as the Internet.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of making a simulation model, comprising:
specifying a feature factor which characterizes a pattern layout of a mask pattern;
specifying a control factor which affects a dimension of a resist pattern to be formed on a substrate by means of a lithography process using the mask pattern;
determining a predicted dimension of the resist pattern to be formed on the substrate by means of the lithography process using the mask pattern through the use of a model based on the feature and control factors;
obtaining an actual dimension of the resist pattern actually formed on the substrate by means of the lithography process using the mask pattern; and
setting the feature and control factors and the predicted dimension as input layers and setting the actual dimension as an output layer to construct a neural network.

2. The method according to claim 1, wherein the feature factor includes at least one of a pattern dimension, a pattern pitch, a pattern area rate, and the number of patterns.

3. The method according to claim 1, wherein the control factor includes at least one of an exposure amount, a focus, an illumination condition, a numerical aperture of an optical system of an exposure apparatus, an aberration of a lens of an exposure apparatus, a type of a photoresist, a mask dimension, and a mask bias.

4. The method according to claim 1, wherein the model based on the feature and control factors includes a physical model specified by the feature and control factors.

5. The method according to claim 4, wherein the physical model includes a physical model which represents diffraction at the mask pattern.

6. The method according to claim 1, wherein the neural network includes an intermediate layer which connects the input layers with the output layer.

7. A method of making a simulation model, comprising:
specifying a feature factor which characterizes a pattern layout of a mask pattern;
specifying a control factor which affects a dimension of a pattern to be formed on a substrate by means of an etching process using a resist pattern based on the mask pattern as a mask;
obtaining an actual dimension of a pattern actually formed on the substrate by means of the etching process using the resist pattern based on the mask pattern as a mask; and
setting the feature and control factors and a dimension of the resist pattern as input layers and setting the actual dimension or a difference between the actual dimension and the dimension of the resist pattern as an output layer to construct a neural network.

8. The method according to claim 7, wherein the feature factor includes at least one of a pattern dimension, a pattern pitch, a pattern area rate, and the number of patterns.

9. The method according to claim 7, wherein the control factor includes at least one of an etching time, an etching temperature, a pressure of an etching atmosphere, and a flow rate of an etching gas.

10. The method according to claim 7, wherein the dimension of the resist pattern is a predicted dimension or an actual dimension of the resist pattern.

11. The method according to claim 7, wherein the neural network includes an intermediate layer which connects the input layers with the output layer.

12. A method of making a simulation model, comprising:
obtaining an actual dimension of a resist pattern actually formed on a substrate by means of a lithography process using a mask pattern;
determining a first intensity distribution based on an optical image of the mask pattern through the use of a first lithography simulation model using a physical parameter;
determining a second intensity distribution by applying a second lithography simulation model using an experimental parameter to the first intensity distribution;
determining a predicted dimension of the resist pattern to be formed on the substrate by means of the lithography process using the mask pattern on the basis of the second intensity distribution;
determining a feature quantity of the second intensity distribution; and
setting the feature quantity as an input layer and setting a difference between the actual and predicted dimensions as an output layer to construct a neural network.

13. The method according to claim 12, wherein the first lithography simulation model includes a physical model which represents diffraction at the mask pattern.

14. The method according to claim 12, wherein the second lithography simulation model includes an experimental model which represents a diffusion of an acid within a photoresist.

15. The method according to claim 12, wherein the feature quantity is obtained by causing a function or a filter to act on the second intensity distribution.

16. The method according to claim 15, wherein the function is selected from a disk function, a Gaussian function, and a Fourier-Bessel function.

17. The method according to claim 15, wherein the filter is selected from an IIR filter and an FIR filter.

18. The method according to claim 12, wherein the neural network includes an intermediate layer which connects the input layer with the output layer.
